(19) United States
(12) Patent Application Publication
(10) Pub. No.: US 2025/0293414 A1
(43) Pub. Date: Sep. 18, 2025

(54) BATTERY

(71) Applicant: KABUSHIKI KAISHA TOSHIBA, Tokyo (JP)

(72) Inventor: Naoki IWAMURA, Yokohama Kanagawa (JP)

(73) Assignee: KABUSHIKI KAISHA TOSHIBA, Tokyo (JP)

(21) Appl. No.: 19/223,123

(22) Filed: May 30, 2025

Related U.S. Application Data
(63) Continuation of application No. PCT/JP2023/010945, filed on Mar. 20, 2023.

(51) Int. Cl. H01M 50/586; H01M 50/172; H01M 50/188; H01M 50/533; H01M 50/552; H01M 50/588

(52) U.S. Cl. CPC H01M 50/586; H01M 50/172; H01M 50/188; H01M 50/533; H01M 50/552; H01M 50/588

(57) ABSTRACT

In an embodiment, a battery includes an outer unit, an electrode group, a terminal, a lead, an insulating gasket, an external insulator, and an internal insulator. A terminal shaft of the terminal is through the outer unit from an outer surface counterbore to an inner surface counterbore. The lead is connected to the terminal shaft, and the insulating gasket sandwiched between the terminal shaft and the outer unit in a state where the terminal shaft is covered from an outer peripheral side. The external insulator is fitted to the outer surface counterbore in a state of being sandwiched between a terminal head of the terminal and the outer surface counterbore, and the internal insulator is fitted to the inner surface counterbore in a state of being sandwiched between the lead and the inner surface counterbore.

### CROSS-REFERENCE TO RELATED APPLICATIONS

This is a Continuation Application of PCT Application No. PCT/JP2023/010945, filed Mar. 20, 2023, the entire contents of which are incorporated herein by reference.

### FIELD

Embodiments described herein relate generally to batteries.

### BACKGROUND

Batteries, such as lithium ion secondary batteries, include a battery in which an electrode group is housed in an inner cavity of an outer unit. In such a battery, terminals (electrode terminals) are attached to the outer unit, and the terminals are electrically connected to the electrode group via leads or the like. In the battery, electrical paths from the electrode group are formed through the leads and the terminals. Terminals used in a battery include a terminal provided with a terminal shaft and a terminal head. In a battery using a terminal provided with a terminal shaft and a terminal head, the terminal shaft is inserted into the inner cavity through the outer unit from an outer surface to an inner surface, and the terminal head is arranged outside the outer unit.

In a battery using a terminal provided with a terminal shaft and a terminal head, an external insulator (terminal insulator) is sandwiched between the outer surface of the outer unit and the terminal head. In addition, in a through-hole through which the terminal shaft penetrates the outer unit, an insulating gasket is sandwiched between the outer unit and the terminal shaft in a state where the terminal shaft is covered from an outer peripheral side. Thus, the terminal is electrically insulated from the outer unit by the external insulator and the insulating gasket. In addition, in the through-hole through which the terminal shaft penetrates the outer unit, the airtightness and the liquid-tightness between the outer unit (a peripheral surface of the through-hole) and the terminal shaft are maintained by the insulating gasket, and leakage of gas, electrolytes and the like from the inner cavity to the outside of the outer unit is prevented. In addition, in a battery using a terminal provided with a terminal shaft and a terminal head, an internal insulator (lead insulator) is sandwiched between the inner surface of the outer unit and the lead in the inner cavity. Thus, the lead is electrically insulated from the outer unit by the internal insulator or the like.

In a battery module including a plurality of batteries, the battery as described above is connected to another battery via a bus bar. In the battery, the bus bar is connected to the terminal. In the battery module, a large load may be applied from the bus bar to the terminal due to thermal expansion of the bus bar or the like caused by energization. For the battery, even when a large load is applied to the terminal from the bus bar or the like, it is required to appropriately secure airtightness or the like between the terminal and the outer unit by the insulating gasket.

### BRIEF DESCRIPTION OF THE DRAWINGS

FIG. 1 is a perspective view showing a battery according to a first embodiment.

FIG. 2 is a perspective view showing each member of the battery according to the first embodiment in an exploded manner.

FIG. 3 is a cross-sectional view showing a structure of one of a pair of terminals and a vicinity thereof in the battery according to the first embodiment in a cross section orthogonal or substantially orthogonal to the depth direction of the battery.

FIG. 4 is a cross-sectional view showing a structure of one of a pair of terminals and a vicinity thereof in a battery according to a first modification in a cross section orthogonal or substantially orthogonal to the depth direction of the battery.

FIG. 5 is a cross-sectional view showing a structure of one of a pair of terminals and a vicinity thereof in a battery according to a second modification in a cross section orthogonal or substantially orthogonal to the depth direction of the battery.

FIG. 6 is a cross-sectional view showing a structure of one of a pair of terminals and a vicinity thereof in a battery according to a third modification in a cross section orthogonal or substantially orthogonal to the depth direction of the battery.

FIG. 7 is a cross-sectional view showing a structure of one of a pair of terminals and a vicinity thereof in a battery according to a fourth modification in a cross section orthogonal or substantially orthogonal to the depth direction of the battery.

### DETAILED DESCRIPTION

According to an embodiment, a battery includes an outer unit, an electrode group, a terminal, a lead, an insulating gasket, an external insulator, and an internal insulator. The outer unit includes an outer surface counterbore that is recessed in the outer surface and an inner surface counterbore that is recessed in the inner surface, and forms an inner cavity. The electrode group includes a positive electrode and a negative electrode and is housed in the inner cavity. The terminal includes a terminal shaft that is inserted into the inner cavity through the outer unit from the outer surface counterbore to the inner surface counterbore, and a terminal head that is arranged outside the outer unit. The lead is connected to the terminal shaft of the terminal in the inner cavity, and the lead electrically connects the electrode group and the terminal. The insulating gasket has electrical insulation properties and is sandwiched between the terminal shaft and the outer unit in a state where the terminal shaft is covered from the outer peripheral side. The external insulator has electrical insulation properties and is fitted to the outer surface counterbore in a state of being sandwiched between the terminal head of the terminal and the outer surface counterbore. The internal insulator has electrical insulation properties and is fitted to the inner surface counterbore in a state of being sandwiched between the lead and the inner surface counterbore.

Hereinafter, embodiments will be described with reference to the drawings.

### First Embodiment

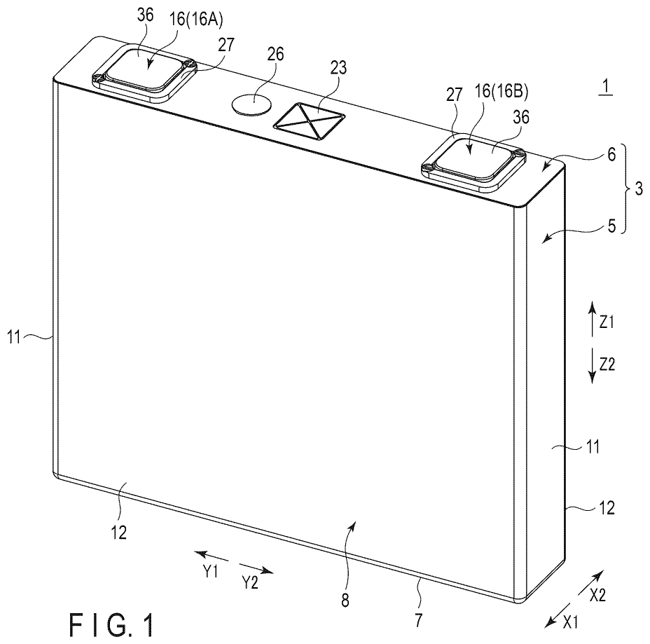

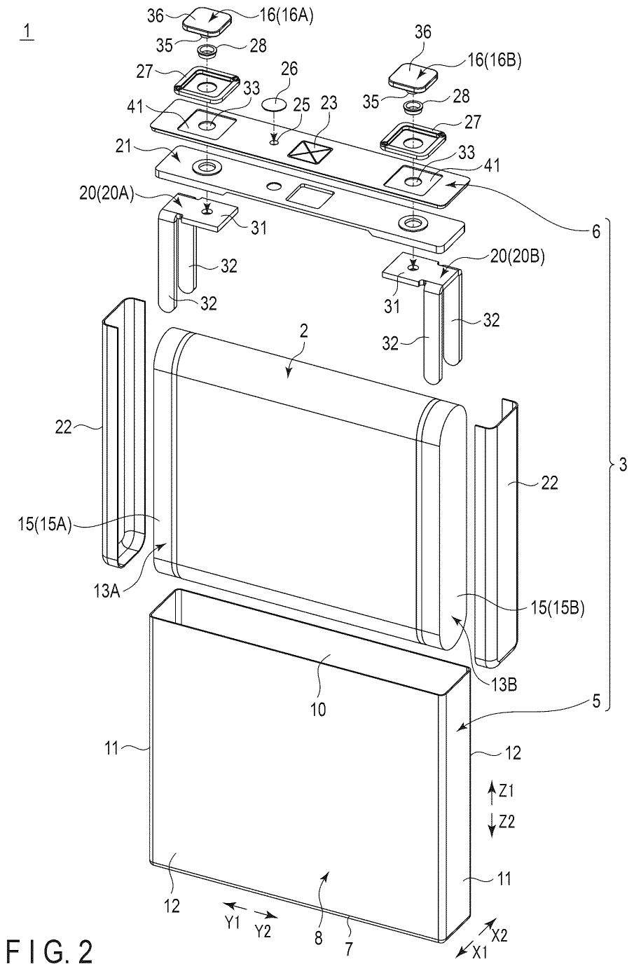

First, the first embodiment will be described as one example of the embodiment. FIGS. 1 and 2 show a battery 1 according to the first embodiment. As shown in FIGS. 1 and 2, a single battery 1 includes an electrode group 2 and an outer unit 3. In one example shown in FIGS. 1 and 2, the outer unit 3 includes an outer container 5 and a lid member 6. The outer unit 3 including the outer container 5 and the lid member 6 is made of metal such as aluminum, an aluminum alloy, iron, copper, or stainless steel, and has conductivity.

Herein, the battery 1 (outer unit 3) of one example shown in FIGS. 1 and 2 is defined in terms of a depth direction (the direction indicated by arrows X1 and X2), a lateral direction (the direction indicated by arrows Y1 and Y2) intersecting the depth direction (orthogonal or substantially orthogonal thereto), and a height direction (the direction indicated by arrows Z1 and Z2) intersecting both the depth direction and the lateral direction (orthogonal or substantially orthogonal thereto). In each of the battery 1 and the outer unit 3, the dimension in the depth direction is smaller than the dimension in the lateral direction and the dimension in the height direction. FIG. 1 is a perspective view, and FIG. 2 is a perspective view showing each member in an exploded manner.

The outer container 5 includes a bottom wall 7 and a peripheral wall 8. An inner cavity 10 is formed inside the outer unit 3, and the inner cavity 10 is defined by the bottom wall 7 and the peripheral wall 8 of the outer container 5. In the outer container 5, the inner cavity 10 is open toward a side opposite to the side where the bottom wall 7 is located in the height direction. The peripheral wall 8 includes two pairs of side walls 11 and 12. The pair of side walls 11 are opposed to each other such that the inner cavity 10 is sandwiched in the lateral direction. The pair of side walls 12 are opposed to each other such that the inner cavity 10 is sandwiched in the depth direction. Each of the side walls 11 continuously extends along the depth direction between the side walls 12. Each of the side walls 12 continuously extends along the lateral direction between the side walls 11. The lid member 6 is attached to the peripheral wall 8 at an end portion opposite to the bottom wall 7. Therefore, the lid member 6 closes the opening of the inner cavity 10. The lid member 6 and the bottom wall 7 face each other, with the inner cavity 10 sandwiched therebetween in the height direction. The lid member 6 is attached to the peripheral wall 8 by welding such as seam welding.

The electrode group 2 is housed in the inner cavity 10. As shown in FIG. 2 etc., the electrode group 2 includes a positive electrode 13A and a negative electrode 13B. A separator (not shown) is interposed between the positive electrode 13A and the negative electrode 13B in the electrode group 2. The separator has electrical insulation properties and electrically insulates the positive electrode 13A from the negative electrode 13B.

The positive electrode 13A includes a positive electrode current collector such as a positive electrode current collecting foil, and a positive electrode active material-containing layer (not shown) supported on the surface of the positive electrode current collector. The positive electrode current collector is, for example, an aluminum foil, an aluminum alloy foil or the like, and has a thickness of about 10 μm to 20 μm, but the positive electrode current collector is not limited to this example. The positive electrode active material-containing layer contains a positive electrode active material and may optionally contain a binder and an electro-conductive agent. Examples of the positive electrode active material are an oxide, a sulfide, and a polymer that can occlude and release lithium ions, but the positive electrode active material is not limited to these examples. The positive electrode current collector includes a positive electrode current collecting tab 15A in a portion where the positive electrode active material-containing layer is not supported.

The negative electrode 13B includes a negative electrode current collector such as a negative electrode current collecting foil, and a negative electrode active material-containing layer (not shown) supported on the surface of the negative electrode current collector. The negative electrode current collector is, for example, an aluminum foil, an aluminum alloy foil, a copper foil, or the like, and has a thickness of about 10 μm to 20 μm, but the negative electrode current collector is not limited to this example. The negative electrode active material-containing layer contains a negative electrode active material and may optionally contain a binder and an electro-conductive agent. Examples of the negative electrode active material are a metal oxide, a metal sulfide, a metal nitride and a carbon material that can occlude and release lithium ions, but the negative electrode active material is not limited to these examples. The negative electrode current collector includes a negative electrode current collecting tab 15B in a portion where the negative electrode active material-containing layer is not supported.

In the electrode group 2 of one example shown in FIG. 2 etc., the positive electrode 13A, the negative electrode 13B, and the separator are wound in the state where the separator is sandwiched between the negative electrode active material-containing layer and the positive electrode active material-containing layer, thereby forming the electrode group 2 having a wound structure. In another example, the electrode group 2 has a stack structure in which a plurality of positive electrode plates serving as the positive electrode 13A and a plurality of negative electrode plates serving as the negative electrode 13B are alternately stacked, and separators are provided between the positive electrode plates and the negative electrode plates. By forming the electrode group 2 as described above, the positive electrode current collecting tab 15A and the negative electrode current collecting tab 15B are formed as a pair of current collecting tabs 15 in the electrode group 2. The pair of current collecting tabs 15 do not come into contact with each other and are electrically insulated from each other.

In the electrode group 2, each of the pair of current collecting tabs 15 protrudes from the positive electrode active material-containing layer, the negative electrode active material-containing layer, the separator, and the like. In one example shown in FIG. 2 etc., the pair of current collecting tabs 15 protrude toward opposite sides. The electrode group 2 is arranged in the inner cavity 10 in a state where the positive electrode current collecting tab 15A protrudes to one side in the lateral direction of the battery 1 and the negative electrode current collecting tab 15B protrudes to the side opposite to the side where the positive electrode current collecting tab 15A protrudes in the lateral direction of the battery 1.

In the inner cavity 10, the electrode group 2 holds (is impregnated with) an electrolytic solution (not shown). The electrolytic solution may be a nonaqueous electrolytic solution in which an electrolyte is dissolved in an organic solvent, or an aqueous electrolytic solution such as an aqueous solution. A gel electrolyte may be used instead of the electrolytic solution, or a solid electrolyte may be used. Where a solid electrolyte is used as the electrolyte, the solid electrolyte in the electrode group is interposed between the positive electrode 13A and the negative electrode 13B, in place of the separator. In this case, the positive electrode 13A is electrically insulated from the negative electrode 13B by the solid electrolyte.

In the battery 1, a pair of terminals (electrode terminals) 16 are attached to the lid member 6 of the outer unit 3. The terminals 16 are made of a conductive material such as metal. One of the pair of terminals 16 is a positive electrode terminal 16A of the battery 1, and the other one of the pair of terminals 16, which is different from the positive electrode terminal 16A, is a negative electrode terminal 16B of the battery 1. Each of the terminals 16 is attached to the lid member 6 in a state where a part of each terminal 16 is located outside the outer unit 3. Each of the terminals 16 penetrates the lid member 6 from the outer surface to the inner surface along the height direction of the battery 1, and is inserted into the inner cavity 10 through the lid member 6. The pair of terminals 16 are arranged apart from each other in the lateral direction of the battery 1.

A pair of leads 20 are arranged in the inner cavity 10 of the outer unit 3. One of the pair of leads 20 is a positive electrode side lead 20A, and the other one of the pair of leads 20, which is different from the positive electrode side lead 20A, is a negative electrode side lead 20B. Each of the leads 20 is made of a conductive material such as metal. Examples of the conductive material forming the leads 20 include aluminum, stainless steel, copper, iron, etc.

The positive electrode side lead 20A forms at least a part of an electrical path between the positive electrode current collecting tab 15A and the positive electrode terminal 16A, and connects the positive electrode 13A of the electrode group 2 and the positive electrode terminal 16A. Thereby, the positive electrode terminal 16A is electrically connected to the positive electrode 13A of the electrode group 2. The negative electrode side lead 20B forms at least a part of an electrical path between the negative electrode current collecting tab 15B and the negative electrode terminal 16B, and connects the negative electrode 13B of the electrode group 2 and the negative electrode terminal 16B. Thereby, the negative electrode terminal 16B is electrically connected to the negative electrode 13B of the electrode group 2. As described above, in the battery 1, each of the pair of current collecting tabs 15 is electrically connected to a corresponding one of the pair of terminals 16 via a corresponding one of the pair of leads 20.

As shown in FIG. 2 etc., in the inner cavity 10, an internal insulator (lead insulator) 21 is arranged between the electrode group 2 and the lid member 6 in the height direction of the battery 1. The internal insulator 21 is arranged between the respective leads 20 and the lid member 6 in the height direction of the battery 1. The internal insulator 21 has electrical insulation properties. By the internal insulator 21, the pair of current collecting tabs 15 and the pair of leads 20 are prevented from coming into contact with the lid member 6 and are electrically insulated from the lid member 6. In the inner cavity 10, each of the terminals 16 penetrates the internal insulator 21 along the height direction of the battery 1, and is connected to a corresponding one of the leads 20 in a state of penetrating the internal insulator 21. In one example shown in FIG. 2 etc., the internal insulator 21 also functions as an electrode group retainer that presses the electrode group 2 toward the side where the bottom wall 7 is located in the height direction and regulates the movement of the electrode group 2 in the height direction.

A pair of insulating guards 22 are arranged in the inner cavity 10 of the outer unit 3. Each of the insulating guards 22 has electrical insulation properties. Each of the pair of insulating guards 22 prevents a corresponding one of the pair of current collecting tabs 15 and a corresponding one of the pair of leads 20 from coming into contact with the outer container 5. Thereby, the pair of current collecting tabs 15 and the pair of leads 20 are electrically insulated from the outer container 5. As described above, in one example shown in FIG. 2 etc., the internal insulator 21 and the pair of insulating guards 22 electrically insulate the pair of current collecting tabs 15 and the pair of leads 20 from the outer unit 3 including the outer container 5 and the lid member 6.

In the battery 1 of one example shown in FIGS. 1 and 2, the lid member 6 has a gas release valve 23 and a liquid injection port 25. A sealing plate 26 that closes the liquid injection port is welded to the outer surface of the lid member 6. The gas release valve 23 and the liquid injection port 25 are arranged between the pair of terminals 16 in the lateral direction of the battery 1. It should be noted that in the battery 1, the gas release valve 23 and the liquid injection port 25 need not be provided.

In one example shown FIG. 2 etc., each of the pair of leads 20 includes a top plate portion 31 and a pair of leg portions 32. In each of the leads 20, the top plate portion 31 faces the inner surface of the lid member 6 with the internal insulator 21 sandwiched therebetween, and the internal insulator 21 is sandwiched between the top plate portion 30 of each of the leads 20 and the inner surface of the lid member 6. In each of the leads 20, a corresponding one of the terminals 16 is connected to the top plate portion 31. Each of the leads 20 is arranged in the inner cavity 10 in a state where the plate thickness direction of the top plate portion 31 coincides or substantially coincides with the height direction of the battery 1.

In each of the leads 20, one end of each of the pair of leg portions 32 is connected to the top plate portion 31, and each of the leg portions 32 extends from the position connected to the top plate portion 31 toward the side where the bottom wall 7 is located in the height direction of the battery 1. In each of the leads 20, the connection position where each of the pair of leg portions 32 is connected to the top plate portion 31 is located laterally outward of the battery 1 with respect to the connection position where a corresponding one of the terminals 16 is connected to the top plate portion 31. In each of the leads 20, each of the leg portions 32 is joined to a corresponding one of the pair of current collecting tabs 15.

In one example shown in FIG. 2 etc., each of the leads 20 includes the pair of (two) leg portions 32, but in a certain example, each of the leads 20 may include only one leg portion 32. In this case as well, the leg portion 32 of each of the leads 20 extends from the position connected to the top plate portion 31 toward the side where the bottom wall 7 is located in the height direction of the battery 1. In addition, in each of the leads 20, one leg portion 32 is joined to a corresponding one of the current collecting tabs 15.

In the battery 1, a pair of through-holes 33 are formed in the outer surface of the lid member 6 of the outer unit 3. In the lid member 6, the pair of through-holes 33 are formed apart from each other in the lateral direction of the battery 1, and each of the through-holes 33 penetrates the lid member 6 along the height direction of the battery 1 from the outer surface of the lid member 6 (the outer surface of the outer unit 3) to the inner surface of the lid member 6 (the inner surface of the outer unit 3). Each of the pair of terminals 16 penetrates the lid member 6 through the corresponding one of the pair of through-holes 33 and is inserted into the inner cavity 10 from the corresponding one of the through-holes 33. Each of the terminals 16 is attached to the lid member 6 at the corresponding one of the pair of through-holes 33 and in the vicinity thereof.

The battery 1 includes a pair of external insulators (terminal insulators) 27 and a pair of insulating gaskets 28. The external insulators 27 and the insulating gaskets 28 are respectively provided one each for the positive electrode terminal 16A and one each for the negative electrode terminal 16B. That is, one external insulator 27 and one insulating gasket 28 are provided for the positive electrode terminal 16A, and one external insulator 27 and one insulating gasket 28 are provided for the negative electrode terminal 16B.

Each of the external insulator 27 and the insulating gasket 28 has electrical insulation properties, and is made of, for example, a resin having electrical insulation properties. Each of the insulating gaskets 28 is formed in, for example, a ring shape or a substantially ring shape. In the present embodiment, each of the terminals 16 is prevented from coming into contact with the lid member 6 by a corresponding one of the external insulators 27 and a corresponding one of insulating gaskets 28 at the portion where each terminal 16 is attached to the lid member 6 of the outer unit 3, and is electrically insulated from the outer unit 3 including the lid member 6.

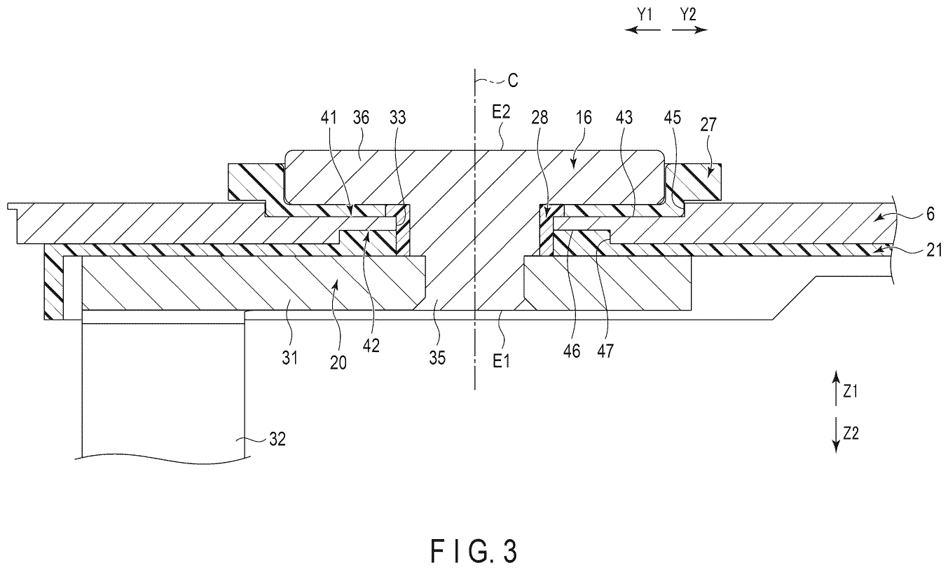

Hereinafter, the structures and the like for one of the pair of terminals 16 and the portion where the terminal 16 is attached to the outer unit 3 (lid member 6) will be described. FIG. 3 shows the structure of one of the pair of terminals 16 and the vicinity thereof. FIG. 3 shows a cross section orthogonal or substantially orthogonal to the depth direction of the battery 1 and passing through the terminal 16. The other of the pair of terminals 16 as well as the portion where the terminal 16 is attached to the outer unit 3 (lid member 6) have the same structure as described below. Therefore, the structures of the other of the pair of terminals 16 as well as the lid member 6 (outer unit 3) and the internal insulator 21 in the vicinity of the terminal 16, and the structures of the lead 20, the external insulator 27 and the insulating gasket 28 corresponding to the terminal 16 are the same as the structures shown in FIG. 3 etc. and the same as the structures described below.

As shown in FIG. 3 etc., the terminal 16 has a central axis C. In the terminal 16 and the portion where it is attached, a direction along the central axis C is defined as an axial direction, and a direction around the central axis C is defined as a circumferential direction. In the terminal 16 and the portion where it is attached, a direction orthogonal or substantially orthogonal to the central axis C is defined as a radial direction. In the terminal 16 and the portion where it is attached, a side away from the central axis C in the radial direction is an outer peripheral side, and a side toward the central axis C in the radial direction is an inner peripheral side. FIG. 3 shows a cross section parallel or substantially parallel to the axial direction of the terminal 16.

The terminal 16 includes a terminal shaft 35 and a terminal head 36. The terminal head 36 is provided adjacent to one side in the axial direction of the terminal 16 with respect to the terminal shaft 35, and the terminal head 36 protrudes to the outer peripheral side with respect to the terminal shaft 35. The terminal head 36 protrudes from the terminal shaft 35 to the outer peripheral side over the entire circumference of the terminal 16 in the circumferential direction (the direction around the central axis C). Therefore, in the terminal 16, the cross-sectional area of the terminal head 36 in a cross section orthogonal or substantially orthogonal to the central axis C is larger than the cross-sectional area of the terminal shaft 35 in a cross section orthogonal or substantially orthogonal to the central axis C. In the terminal 16, an end E1 on one side in the axial direction is formed by the terminal shaft 35, and an end E2 on the opposite side to the end E1 in the axial direction is formed by the terminal head 36. The terminal 16 is attached to the lid member 6 in a state where the central axis C is along the height direction of the battery 1, that is, in a state where the axial direction coincides or substantially coincides with the height direction of the battery 1.

In the terminal 16, the terminal shaft 35 is inserted into the inner cavity 10 through the through-hole 33 of the lid member 6. That is, each terminal shaft 35 of the positive electrode terminal 16A and the negative electrode terminal 16B is inserted into the inner cavity 10 through the corresponding one of the pair of through-holes 33. In the inner cavity 10, the terminal shaft 35 of the terminal 16 penetrates the internal insulator 21. In the inner cavity 10, the terminal shaft 35 of the terminal 16 is connected to the top plate portion 31 of the lead 20 (the corresponding one of the positive electrode side lead 20A and the negative electrode side lead 20B) between the electrode group 2 and the internal insulator 21 in the height direction of the battery 1.

The terminal head 36 of the terminal 16 is arranged outside the outer unit 3. In the terminal 16, as described above, the terminal head 36 protrudes to the outer peripheral side with respect to the terminal shaft 35. Therefore, in the terminal 16, a step is formed at a boundary portion between the terminal head 36 and the terminal shaft 35. In the terminal 16, because of the step at the boundary portion between the terminal shaft 35 and the terminal head 36, the outer peripheral surface of the terminal head 36 is located on the outer peripheral side with respect to the outer peripheral surface of the terminal shaft 35. In the terminal shaft 35, the outer peripheral surface forms an outer peripheral end, and in the terminal head 36, the outer peripheral surface forms an outer peripheral end.

In addition, at the portion where the terminal 16 is attached, an outer surface counterbore 41 is formed in the outer surface of the lid member 6 (outer unit 3), and an inner surface counterbore 42 is formed in the inner surface of the lid member 6 (outer unit 3). The outer surface counterbore (outer surface recess) 41 is recessed toward a side in which the inner surface is located in the outer surface of the lid member 6, and the inner surface counterbore (inner surface recess) 42 is recessed toward a side in which the outer surface is located in the inner surface of the lid member 6. The outer surface counterbore 41 includes a bottom surface 43 and an outer peripheral surface 45, and an outer peripheral end of the outer surface counterbore 41 is formed by the outer peripheral surface 45. The inner surface counterbore 42 includes a bottom surface 46 and an outer peripheral surface 47, and an outer peripheral end of the inner surface counterbore 42 is formed by the outer peripheral surface 47. At the attachment portion of the terminal 16, the through-hole 33 penetrates the lid member 6 from the bottom surface 43 of the outer surface counterbore 41 to the bottom surface 46 of the inner surface counterbore 42. Therefore, the terminal shaft 35 of the terminal 16 penetrates the lid member 6 (outer unit 3) from the outer surface counterbore 41 to the inner surface counterbore 42, and is inserted into the inner cavity 10.

The insulating gasket 28 covers the terminal shaft 35 of the terminal 16 from the outer peripheral side in the through-hole 33 (the corresponding one of the pair of through-holes 33). The insulating gasket 28 covers the terminal shaft 35 from the outer peripheral side over the entire circumference of the terminal 16 in the circumferential direction. At the attachment portion of the terminal 16, the insulating gasket 28 is sandwiched between the terminal shaft 35 of the terminal 16 and the peripheral surface of the through-hole 33. That is, the insulating gasket 28 is sandwiched between the terminal shaft 35 and the lid member 6 of the outer unit 3 in the through-hole 33.

With the above-described structure, by the insulating gasket 28, the terminal 16 is prevented from coming into contact with the peripheral surface of the through-hole 33. Furthermore, by the insulating gasket 28, the airtightness and the liquid-tightness between the lid member 6 of the outer unit 3 and the terminal shaft 35 of the terminal 16 are maintained in the through-hole 33. Therefore, at the portion where the terminal 16 is attached to the outer unit 3, by the insulating gasket 28, leakage of electrolytes, gas and the like from the inner cavity 10 to the outside of the outer unit 3 through the through-hole 33 is prevented.

As shown in FIG. 3 etc., at the attachment portion of the terminal 16, the external insulator (terminal insulator) 27 is sandwiched between the outer surface counterbore 41 and the terminal head 36 of the terminal 16. The external insulator 27 covers the terminal head 36 from the outer peripheral side over the entire circumference of the terminal 16 in the circumferential direction. At the attachment portion of the terminal 16, a portion of the external insulator 27 sandwiched between the outer surface counterbore 41 and the terminal head 36 is adjacent to the insulating gasket 28 from the outer peripheral side. Therefore, at the attachment portion of the terminal 16, the external insulator 27, the insulating gasket 28, and the terminal shaft 35 are arranged in this order from the outer peripheral side.

The external insulator 27 is inserted into the outer surface counterbore 41 and fitted to the outer surface counterbore 41. Therefore, the external insulator 27 comes into contact with the outer peripheral surface 45 of the outer surface counterbore 41 from the inner peripheral side over the entire circumference or substantially the entire circumference of the terminal 16 in the circumferential direction. In the external insulator 27, an outer peripheral end is formed by the outer peripheral surface. In the present embodiment, the outer peripheral surface (outer peripheral end) of the external insulator 27 is located on the outer peripheral side with respect to the outer peripheral surface 45 (outer peripheral end) of the outer surface counterbore 41. Therefore, at the attachment portion of the terminal 16, the external insulator 27 extends to the outer peripheral side beyond the outer peripheral end of the outer surface counterbore 41. The external insulator 27 extends further toward the outer peripheral side from the outer peripheral end of the outer surface counterbore 41 over the entire circumference of the terminal 16 in the circumferential direction.

In one example shown in FIG. 3 etc., the outer peripheral end of the outer surface counterbore 41 is located on the outer peripheral side with respect to the outer peripheral end of the terminal head 36 of the terminal 16 and is located on the side far from the through-hole 33. Therefore, at the attachment portion of the terminal 16, the entire terminal head 36 is arranged on the inner peripheral side with respect to the outer peripheral surface 45 of the outer surface counterbore 41. In one example shown in FIG. 3 etc., a portion of the external insulator 27 extending to the outer peripheral side beyond the outer peripheral end of the outer surface counterbore 41 is not sandwiched between the terminal head 36 and the outer surface counterbore 41.

In addition, at the attachment portion of the terminal 16, the internal insulator (lead insulator) 21 is sandwiched between the inner surface counterbore 42 and the top plate portion 31 of the lead 20. At the attachment portion of the terminal 16, a portion of the internal insulator 21 sandwiched between the inner surface counterbore 42 and the top plate portion 31 is adjacent to the insulating gasket 28 from the outer peripheral side. Therefore, at the attachment portion of the terminal 16, the internal insulator 21, the insulating gasket 28, and the terminal shaft 35 are arranged in this order from the outer peripheral side. The internal insulator 21 is inserted into the inner surface counterbore 42 and fitted to the inner surface counterbore 42. Therefore, the internal insulator 21 comes into contact with the outer peripheral surface 47 of the inner surface counterbore 42 from the inner peripheral side over the entire circumference or substantially the entire circumference of the terminal 16 in the circumferential direction.

In the present embodiment, at the attachment portion of the terminal 16, the internal insulator 21 extends to the outer peripheral side beyond the outer peripheral surface 47 (outer peripheral end) of the inner surface counterbore 42. The internal insulator 21 extends further toward the outer peripheral side from the outer peripheral end of the inner surface counterbore 42 over the entire circumference of the terminal 16 in the circumferential direction. In the present embodiment, at the attachment portion of the terminal 16, the top plate portion 31 of the lead 20 extends to the outer peripheral side beyond the outer peripheral surface 47 (outer peripheral end) of the inner surface counterbore 42. The top plate portion 31 extends further toward the outer peripheral side from the outer peripheral end of the inner surface counterbore 42 over the entire circumference of the terminal 16 in the circumferential direction.

Since the inner surface counterbore 42, the internal insulator 21, and the top plate portion 31 of the lead 20 are formed as described above, in the present embodiment, the internal insulator 21 is sandwiched between the top plate portion 31 and the inner surface counterbore 42 in a region on the inner peripheral side with respect to the outer peripheral end (outer peripheral surface 47) of the inner surface counterbore 42. In a region on the outer peripheral side with respect to the outer peripheral end of the inner surface counterbore 42, the internal insulator 21 is sandwiched between the top plate portion 31 and a portion of the inner surface of the lid member 6 other than the inner surface counterbore 42. In one example shown in FIG. 3 etc., the outer peripheral end of the inner surface counterbore 42 is located on the inner peripheral side with respect to the outer peripheral end of the terminal head 36 of the terminal 16 and is located on the side close to the through-hole 33. Therefore, at the attachment portion of the terminal 16, the entire inner surface counterbore 42 is arranged on the inner peripheral side with respect to the outer peripheral surface of the terminal head 36.

In a battery module formed by a plurality of batteries including the battery 1, the battery 1 is connected to other batteries via a bus bar. In the battery 1, the bus bar is connected to the terminal 16. In the battery module, a large load may be applied from the bus bar to the terminals 16 due to thermal expansion of the bus bar or the like caused by energization. For example, a large load may be applied from the bus bar to the terminals 16 in a direction intersecting the central axis C (axial direction) due to thermal expansion of the bus bar.

In the present embodiment, as described above, the outer surface counterbore 41 and the inner surface counterbore 42 are formed in the outer unit 3 at the attachment portion of each terminal 16. The external insulator 27 is fitted to the outer surface counterbore 41 in a state of being sandwiched between the terminal head 36 of the terminal 16 and the outer surface counterbore 41, and the internal insulator 21 is fitted to the inner surface counterbore 42 in a state of being sandwiched between the lead 20 and the inner surface counterbore 42. With such a structure, at the attachment portion of each terminal 16, even when a large load is applied to the terminal 16 from the bus bar or the like, by the outer peripheral surface 45 of the outer surface counterbore 41 or the like, the deformations of the insulating gasket 28 and the external insulator 27 due to the load applied to the terminal 16 are reduced. Furthermore, by the outer peripheral surface 47 of the inner surface counterbore 42 or the like, the deformations of the insulating gasket 28 and the internal insulator 21 due to the load applied to the terminal 16 are reduced.

Since the deformation of the insulating gasket 28 caused by the load on the terminal 16 is reduced, even when a large load is applied to the terminal 16, the airtightness and the liquid-tightness between the terminal shaft 35 of the terminal 16 and the outer unit 3 (the lid member 6) by the insulating gasket 28 are appropriately secured in the through-hole 33. Thus, at the attachment portion of each terminal 16, even when a large load is applied to the terminal 16, leakage of electrolytes, gas and the like from the inner cavity 10 to the outside of the outer unit 3 is effectively prevented.

In the present embodiment, at the attachment portion of each terminal 16, the top plate portion 31 of the lead 20 extends to the outer peripheral side beyond the outer peripheral end (outer peripheral surface 47) of the inner surface counterbore 42. Therefore, the internal insulator 21 is sandwiched between the top plate portion 31 and the inner surface of the outer unit 3 at a portion fitted to the inner surface counterbore 42, and is also sandwiched between the top plate portion 31 and the inner surface of the outer unit 3 in a region on the outer peripheral side with respect to the inner surface counterbore 42. Thus, the deformations of the insulating gasket 28 and the internal insulator 21 due to the load on the terminal 16 are further reduced. Therefore, the airtightness and the liquid-tightness of the insulating gasket 28 are further improved at the attachment portion of each terminal 16.

In one example shown in FIG. 3 etc., the outer peripheral end of the inner surface counterbore 42 is located on the inner peripheral side with respect to the outer peripheral end of the terminal head 36, and thus the outer peripheral end of the inner surface counterbore 42 is located at a position close to the through-hole 33. At the attachment portion of each terminal 16, the outer peripheral end of the inner surface counterbore 42 is located at a position close to the through-hole 33, and thus the deformations of the insulating gasket 28 and the internal insulator 21 due to the load on the terminal 16 are further reduced. Therefore, the airtightness and the liquid-tightness of the insulating gasket 28 are further improved at the attachment portion of each terminal 16.

### Modifications

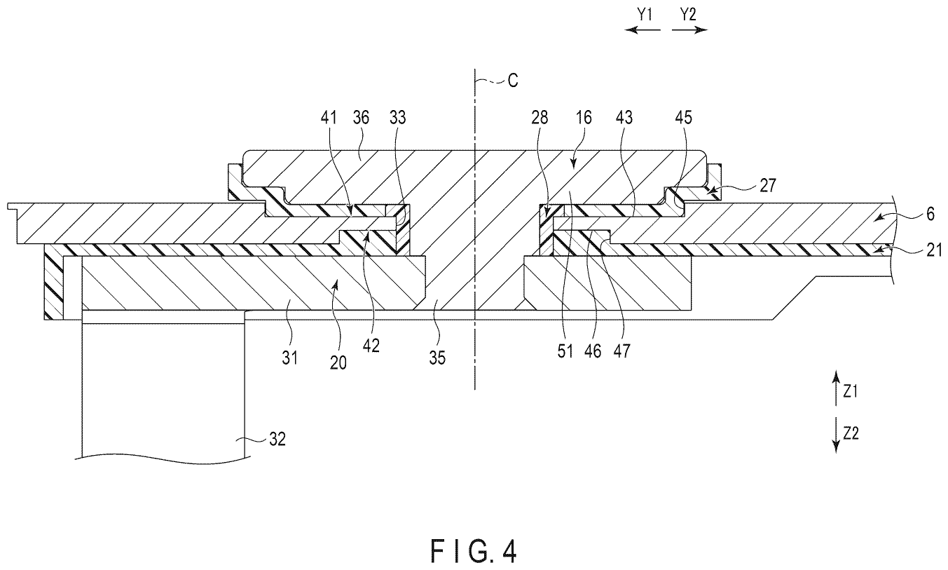

FIG. 4 shows a structure of one of a pair of terminals 16 and a vicinity thereof in a first modification. FIG. 4 shows a cross section that is orthogonal or substantially orthogonal to the depth direction of the battery 1 and passes through the terminal 16. Furthermore, FIG. 4 shows a cross section parallel or substantially parallel to the axial direction (central axis C) of the terminal 16. Hereinafter, the structures and the like for one of the pair of terminals 16 and the portion where the terminal 16 is attached to the outer unit 3 (lid member 6) will be described. The other of the pair of terminals 16 as well as the portion where the terminal 16 is attached to the outer unit 3 (lid member 6) have the same structure as described below.

As shown in FIG. 4 etc., in the present modification as well, the outer surface counterbore 41 and the inner surface counterbore 42 are formed in the outer unit 3 at the attachment portion of the terminal 16. The external insulator 27 is fitted to the outer surface counterbore 41 in a state of being sandwiched between the terminal head 36 of the terminal 16 and the outer surface counterbore 41, and the internal insulator 21 is fitted to the inner surface counterbore 42 in a state of being sandwiched between the lead 20 and the inner surface counterbore 42.

However, in the present modification, the outer peripheral end of the outer surface counterbore 41 is located on the inner peripheral side with respect to the outer peripheral end of the terminal head 36 of the terminal 16 and is located on the side close to the through-hole 33. The terminal head 36 extends to the outer peripheral side beyond the outer peripheral surface 45 (outer peripheral end) of the outer surface counterbore 41. In one example shown in FIG. 4 etc., the terminal head 36 protrudes further toward the outer peripheral side from the outer peripheral end of the outer surface counterbore 41 over the entire circumference of the terminal 16 in the circumferential direction. In this modification, a portion of the external insulator 27 extending to the outer peripheral side beyond the outer peripheral end of the outer surface counterbore 41 covers the terminal head 36 from the outer peripheral side.

In the present modification, the terminal head 36 includes a head protruding portion 51 that protrudes toward the bottom surface 43 of the outer surface counterbore 41. The head protruding portion 51 is formed over the entire circumference of the terminal 16 in the circumferential direction. In the terminal head 36, the head protruding portion 51 is adjacent to the inner peripheral side with respect to the portion that does not protrude toward the outer surface counterbore 41, and the outer peripheral end of the terminal head 36 does not protrude toward the outer surface counterbore 41. In the terminal head 36, because of the head protruding portion 51, a step is formed at the outer peripheral end of the head protruding portion 51, and because of the step formed by the head protruding portion 51, the protruding end surface of the head protruding portion 51 is located closer to the bottom surface 43 of the outer surface counterbore 41 than the portion other than the head protruding portion 51 of the terminal head 36.

At the attachment position of the terminal 16, the outer peripheral end of the head projecting portion 51 is located on the inner peripheral side with respect to the outer peripheral end of the outer surface counterbore 41, and the entire head protruding portion 51 is located on the inner peripheral side with respect to the outer peripheral end of the outer surface counterbore 41. The external insulator 27 is sandwiched between the protruding end surface of the head protruding portion 51 and the outer surface counterbore 41. By providing the head protruding portion 51 as described above, because of the above-described step formed by the head protruding portion 51 in the terminal head 36, the portion of the external insulator 27 sandwiched between the terminal head 36 and the outer surface counterbore 41 has a crank shape in a cross section parallel or substantially parallel to the axial direction of the terminal 16.

The present modification also achieves the same operation and effect as those of the above-described embodiment and the like. In addition, in the present modification, at the attachment portion of each terminal 16, the outer peripheral end (outer peripheral surface 45) of the outer surface counterbore 41 is located on the inner peripheral side with respect to the outer peripheral end of the terminal head 36. Therefore, the external insulator 27 is sandwiched between the terminal head 36 and the outer surface of the outer unit 3 at a portion fitted to the outer surface counterbore 41, and is also sandwiched between the terminal head 36 and the outer surface of the outer unit 3 in a region on the outer peripheral side with respect to the outer surface counterbore 41. Thus, the deformations of the insulating gasket 28 and the external insulator 27 due to the load on the terminal 16 are further reduced. Therefore, the airtightness and the liquid-tightness of the insulating gasket 28 are further improved at the attachment portion of each terminal 16.

In the present modification, the head protruding portion 51 is formed in the terminal head 36 as described above, and because of the head protruding portion 51, the portion of the external insulator 27 sandwiched between the terminal head 36 and the outer surface counterbore 41 has a crank shape in a cross section parallel to the axial direction of the terminal 16. Therefore, at the attachment portion of each terminal 16, the deformations of the insulating gasket 28 and the external insulator 27 due to the load on the terminal 16 are further reduced. Therefore, the airtightness and the liquid-tightness of the insulating gasket 28 are further improved at the attachment portion of each terminal 16.

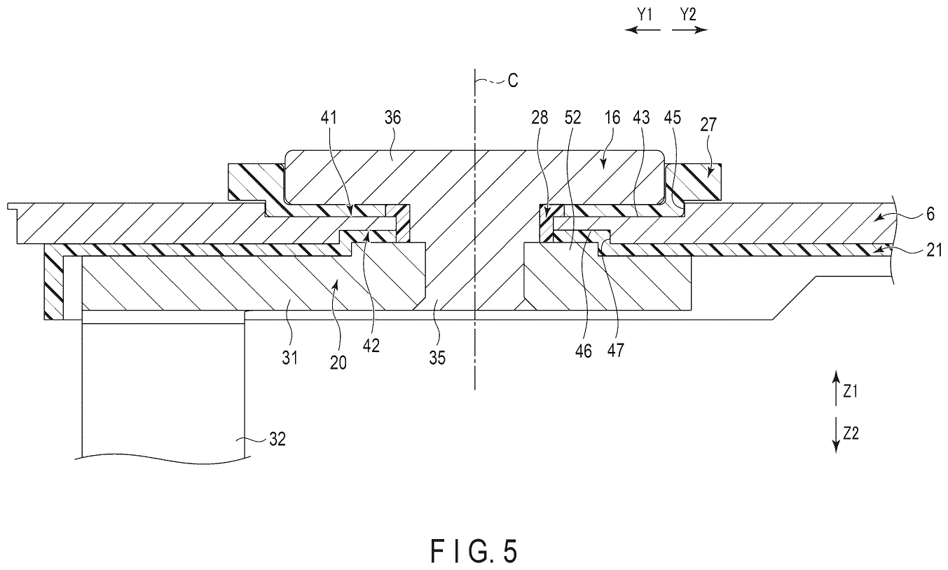

FIG. 5 shows a structure of one of the pair of terminals 16 and a vicinity thereof in the second modification. FIG. 5 shows a cross section that is orthogonal or substantially orthogonal to the depth direction of the battery 1 and passes through the terminal 16. Furthermore, FIG. 5 shows a cross section parallel or substantially parallel to the axial direction (central axis C) of the terminal 16. In the following description, the structure etc. of one of the pair of terminals 16 and the structure of the portion where the terminal 16 is attached to the outer unit 3 (lid member 6) will be described. The other of the pair of terminals 16 and the portion of the terminal 16 attached to the outer unit 3 (lid member 6) have the same structure as described below.

As shown in FIG. 5 etc., in the present modification as in the first embodiment etc., the outer surface counterbore 41 and the inner surface counterbore 42 are formed in the outer unit 3 at the attachment portion of the terminal 16. The external insulator 27 is fitted to the outer surface counterbore 41 in a state of being sandwiched between the terminal head 36 of the terminal 16 and the outer surface counterbore 41, and the internal insulator 21 is fitted to the inner surface counterbore 42 in a state of being sandwiched between the lead 20 and the inner surface counterbore 42.

In the present modification, the top plate portion 31 of the lead 20 includes a lead protruding portion 52 that protrudes toward the bottom surface 46 of the inner surface counterbore 42. The lead protruding portion 52 is formed over the entire circumference of the terminal 16 in the circumferential direction. In the top plate portion 31, the lead protruding portion 52 is adjacent to the inner peripheral side with respect to the portion that does not protrude toward the inner surface counterbore 42. In the top plate portion 31, because of the lead protruding portion 52, a step is formed at the outer peripheral end of the lead protrusion portion 52, and because of the step formed by the lead protruding portion 52, the protruding end surface of the lead protruding portion 52 is located closer to the bottom surface 46 of the inner surface counterbore 42 than the portion other than the lead protruding portion 52 of the top plate portion 31.

At the attachment position of the terminal 16, the outer peripheral end of the lead protruding portion 52 is located on the inner peripheral side with respect to the outer peripheral end of the inner surface counterbore 42, and the entire lead protruding portion 52 is located on the inner peripheral side with respect to the outer peripheral end of the inner surface counterbore 42. The internal insulator 21 is sandwiched between the protruding end surface of the lead protruding portion 52 and the inner surface counterbore 42. By providing the lead protruding portion 52 as described above, because of the above-described step formed by the lead protruding portion 52 in the top plate portion 31 of the lead 20, the portion of the internal insulator 21 sandwiched between the lead 20 and the inner surface counterbore 42 has a crank shape in a cross section parallel or substantially parallel to the axial direction of the terminal 16.

The present modification also achieves the same operation and effect as those of the above-described embodiment and the like. In the present modification, the lead protruding portion 52 is formed in the lead 20 as described above, and because of the lead protruding portion 52, the portion of the internal insulator 21 sandwiched between the lead 20 and the inner surface counterbore 42 has a crank shape in a cross section parallel to the axial direction of the terminal 16. Therefore, at the attachment portion of each terminal 16, the deformations of the insulating gasket 28 and the internal insulator 21 due to the load on the terminal 16 are further reduced. Therefore, the airtightness and the liquid-tightness of the insulating gasket 28 are further improved at the attachment portion of each terminal 16.

In a certain modification, as in the first modification shown in FIG. 4, the outer peripheral end of the outer surface counterbore 41 is located on the inner peripheral side with respect to the outer peripheral end of the terminal head 36 of the terminal 16. Unlike the above-described embodiment etc., the entire top plate portion 31 of the lead 20 is located on the inner peripheral side with respect to the outer peripheral end of the inner surface counterbore 42. That is, the top plate portion 31 does not extend in a region on the outer peripheral side with respect to the outer peripheral end of the inner surface counterbore 42. In another modification, the head protruding portion 51 is provided in the terminal head 36 as in the first modification shown in FIG. 4, and the lead protruding portion 52 is provided in the top plate portion 31 of the lead 20 as in the second modification shown in FIG. 5. That is, both the head protruding portion 51 and the lead protruding portion 52 are provided at the attachment portion of each terminal 16.

In these modifications, as in the above-described embodiment etc., the outer surface counterbore 41 and the inner surface counterbore 42 are formed in the outer unit 3 at the attachment portion of each terminal 16. The external insulator 27 is fitted to the outer surface counterbore 41 in a state of being sandwiched between the terminal head 36 of the terminal 16 and the outer surface counterbore 41, and the internal insulator 21 is fitted to the inner surface counterbore 42 in a state of being sandwiched between the lead 20 and the inner surface counterbore 42. Therefore, the same operation and effect as those of the above-described embodiment and the like are achieved.

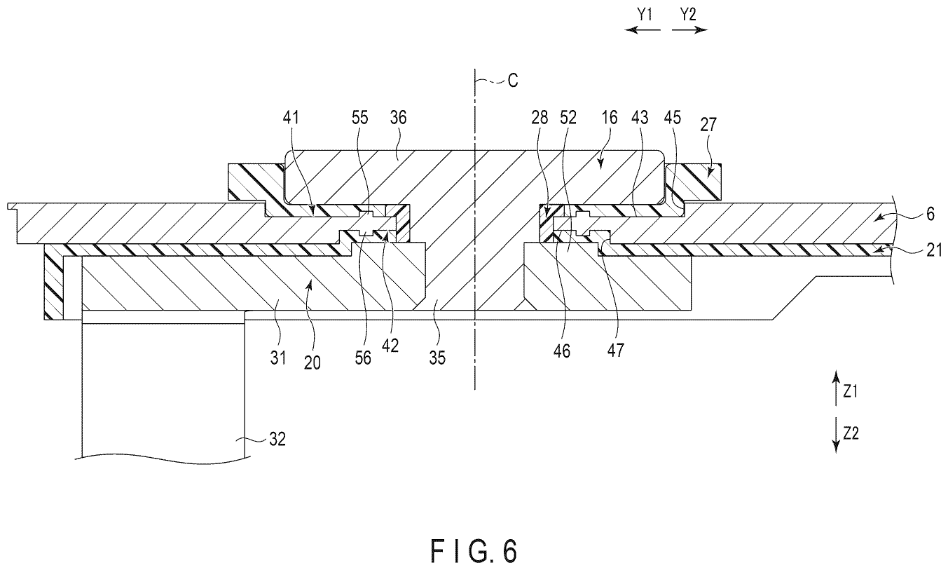

FIG. 6 shows a structure of one of the pair of terminals 16 and a vicinity thereof in the third modification. FIG. 6 shows a cross section that is orthogonal or substantially orthogonal to the depth direction of the battery 1 and passes through the terminal 16. Furthermore, FIG. 6 shows a cross section parallel or substantially parallel to the axial direction (central axis C) of the terminal 16. In the following description, the structure etc. of one of the pair of terminals 16 and the structure of the portion where the terminal 16 is attached to the outer unit 3 (lid member 6) will be described. The other of the pair of terminals 16 and the portion of the terminal 16 attached to the outer unit 3 (lid member 6) have the same structure as described below.

As shown in FIG. 6 etc., in the present modification, the attachment portion of the terminal 16 has the same structure as that of the second modification shown in FIG. 5 except that an outer surface convex portion 55 and an inner surface convex portion 56 described below are provided. At the attachment portion of the terminal 16, the outer surface convex portion 55 protrudes toward the terminal head 36 of the terminal 16 on the bottom surface 43 of the outer surface counterbore 41. The outer surface convex portion 55 is located on the inner peripheral side with respect to the outer peripheral surface 45 of the outer surface counterbore 41 and comes into contact with the external insulator 27. The outer surface convex portion 55 may be provided over the entire circumference or only over a part in the circumferential direction of the terminal 16. However, it is preferable that the outer surface convex portion 55 be formed over the entire circumference of the terminal 16 in the circumferential direction.

At the attachment portion of the terminal 16, the inner surface convex portion 56 protrudes toward the top plate portion 31 of the lead 20 on the bottom surface 46 of the inner surface counterbore 42. The inner surface convex portion 56 is located on the inner peripheral side with respect to the outer peripheral surface 47 of the inner surface counterbore 42 and comes into contact with the internal insulator 21. The inner surface convex portion 56 may be provided over the entire circumference or only over a part of the terminal 16 in the circumferential direction. However, it is preferable that the inner surface convex portion 56 be formed over the entire circumference of the terminal 16 in the circumferential direction.

The present modification also achieves the same operation and effect as those of the above-described embodiment and the like. In this modification, the outer surface convex portion 55 described above is provided on the outer surface of the lid member 6 at the attachment portion of each terminal 16. Therefore, at the attachment portion of each terminal 16, the deformations of the insulating gasket 28 and the external insulator 27 due to the load on the terminal 16 are further reduced. In this modification, the inner surface convex portion 56 described above is provided on the inner surface of the lid member 6 at the attachment portion of each terminal 16. Therefore, at each attachment portion of the terminal 16, the deformations of the insulating gasket 28 and the internal insulator 21 due to the load on the terminal 16 are further reduced. Therefore, the airtightness and the liquid-tightness of the insulating gasket 28 are further improved at the attachment portion of each terminal 16.

In the present modification, in a case where the outer surface convex portion 55 is formed over the entire circumference of the terminal 16 in the circumferential direction, the deformations of the insulating gasket 28 and the external insulator 27 due to the load on the terminal 16 are further reduced at the attachment portion of each terminal 16. Similarly, in a case where the inner surface convex portion 56 is formed over the entire circumference of the terminal 16 in the circumferential direction, the deformations of the insulating gasket 28 and the internal insulator 21 due to the load on the terminal 16 are further reduced at the attachment portion of each terminal 16. In a certain modification, either the outer surface convex portion 55 or the inner surface convex portion 56 may only be formed at the attachment portion of each terminal 16.

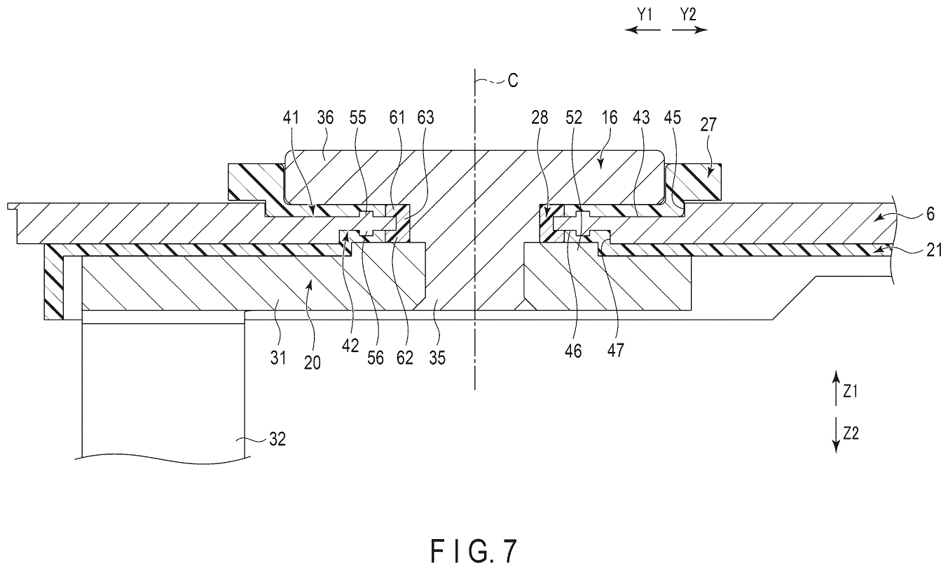

FIG. 7 shows a structure of one of the pair of terminals 16 and a vicinity thereof in the fourth modification. FIG. 7 shows a cross section that is orthogonal or substantially orthogonal to the depth direction of the battery 1 and passes through the terminal 16. Furthermore, FIG. 7 shows a cross section parallel or substantially parallel to the axial direction (central axis C) of the terminal 16. In the following description, the structure etc. of one of the pair of terminals 16 and the structure of the portion where the terminal 16 is attached to the outer unit 3 (lid member 6) will be described. The other of the pair of terminals 16 and the portion of the terminal 16 attached to the outer unit 3 (lid member 6) have the same structure as described below.

As shown in FIG. 7 etc., in the present modification, the attachment portion of the terminal 16 has the same structure as that of the third modification shown in FIG. 6 except that an insulating gasket 28 having a structure described below is provided. In the present modification, the insulating gasket 28 includes flange portions 61 and 62 and a relay portion 63. Each of the flange portions 61 and 62 protrudes to the outer peripheral side with respect to the relay portion 63 over the entire circumference of the terminal 16 in the circumferential direction. In the insulating gasket 28, the flange portion (first flange portion) 61 is provided at an end portion on one side in the axial direction of the terminal 16, and the flange portion (second flange portion) 62 is provided at an end portion on the side opposite to the flange portion 61 in the axial direction of the terminal 16. Therefore, in the insulating gasket 28, the flange portion 61 protrudes to the outer peripheral side at the end portion on one side in the axial direction of the terminal 16, and the flange portion 62 protrudes to the outer peripheral side at the end portion on the side opposite to the flange portion 61 in the axial direction of the terminal 16. In the insulating gasket 28, the relay portion 63 relays the flange portions 61 and 62 and extend along the axial direction of the terminal 16 between the flange portions 61 and 62.

At the attachment portion of the terminal 16, the relay portion 63 of the insulating gasket 28 is sandwiched between the terminal shaft 35 and the lid member 6 (the peripheral surface of the through-hole 33) in the through-hole 33. The external insulator 27 is adjacent to the flange portion 61 of the insulating gasket 28 from the outer peripheral side. The flange portion 61 is sandwiched between the terminal head 36 and the bottom surface 43 of the outer surface counterbore 41. The internal insulator 21 is adjacent to the flange portion 62 of the insulating gasket 28 from the outer peripheral side. The flange portion 62 is sandwiched between the top plate portion 31 of the lead 20 and the bottom surface 46 of the inner surface counterbore 42.

The present modification also achieves the same operation and effect as those of the above-described embodiment and the like. In a case where the insulating gasket 28 including the flange portions 61 and 62 is provided as in the present modification, the above-described operation and effect become more significant by fitting the external insulator 27 into the outer surface counterbore 41 and fitting the internal insulator 21 into the inner surface counterbore 42.

In the present modification, the insulating gasket 28 is provided with the flange portions 61 and 62, and thus the insulating gasket 28 is sandwiched between the terminal head 36 and the outer surface counterbore 41 and between the lead 20 and the inner surface counterbore 42 in addition to being sandwiched between the peripheral surface of the through-hole 33 and the terminal shaft 35. Therefore, the sealing performance of the insulating gasket 28 is further improved at the attachment portion of each terminal 16.

According to the above-described embodiment etc., the pair of current collecting tabs 15 protrude to the sides opposite to each other in the lateral direction of the battery 1 in the electrode group 2, but the structure is not limited to this. In a certain modification, the pair of current collecting tabs 15 protrude toward the same side in the electrode group 2. In this case, the electrode group 2 is arranged in the inner cavity 10 in a state where the pair of current collecting tabs 15 (the positive electrode current collecting tab 15A and the negative electrode current collecting tab 15B) protrude toward the side where the lid member 6 is located in the height direction of the battery 1. The pair of current collecting tabs 15 are arranged apart from each other in the lateral direction of the battery 1. In the present modification as well, each of the pair of current collecting tabs 15 is electrically connected to a corresponding one of the pair of terminals 16 (the positive electrode terminal 16A and the negative electrode terminals 16B) via a corresponding one of the pair of leads 20 (the positive electrode side lead 20A and the negative electrode side lead 20B).

In the present modification, each of the leads 20 includes the top plate portion 31 and the side plate portion instead of including the top plate portion 31 and one or more leg portions 32. Each of the leads 20 is arranged in the inner cavity 10 in a state where the plate thickness direction of the top plate portion 31 coincides or substantially coincides with the height direction of the battery 1 and the plate thickness direction of the side plate portion coincides or substantially coincides with the depth direction of the battery 1. In each of the leads 20, the side plate portion is connected to an edge on one side of the top plate portion 31 in the depth direction of the battery 1. In each of the leads 20, the side plate portion extends from the connection position to the top plate portion 31 toward the side where the electrode group 2 is located in the height direction of the battery. Therefore, each of the leads 20 has an L shape or a substantially L shape in a cross section orthogonal or substantially orthogonal to the lateral direction of the battery 1. A battery or the like in which a pair of current collecting tabs protrude toward a lid member is disclosed in Reference Document 1 (Jpn. Pat. Appln. KOKAI Publication No. 2012-209260) or the like.

In the present modification as well, a corresponding one of the terminals 16 is connected to the top plate portion 31 of each of the leads 20. In each of the leads 20, a corresponding one of the pair of current collecting tabs 15 is joined to the side plate portion. In the present modification as well, the portion where each terminal 16 is attached to the outer unit 3 (lid member 6) has the same structure as that of any of the above-described embodiments etc. Therefore, the same operation and effect as those of the above-described embodiment and the like are achieved.

In the above-described embodiment etc., the outer unit 3 includes the outer container 5 and the lid member 6, but the structure of the outer unit is not limited thereto. As long as the pair of terminals 16 are attached to the outer unit, the same structure as that of any of the above-described embodiments and the like can be applied to the attachment portion where each terminal 16 is attached to the outer unit.

That is, in the above-described embodiment, modifications and the like, the outer surface counterbore 41 and the inner surface counterbore 42 are formed in outer unit 3 at the attachment portion where each terminal 16 is attached to the outer unit. The external insulator 27 is fitted to the outer surface counterbore 41 in a state of being sandwiched between the terminal head 36 of the terminal 16 and the outer surface counterbore 41, and the internal insulator 21 is fitted to the inner surface counterbore 42 in a state of being sandwiched between the lead 20 and the inner surface counterbore 42. With such a structure, even when a large load is applied to the terminals 16, the airtightness and the liquid-tightness of the insulating gasket 28 are appropriately ensured at the attachment portion of each terminal 16.

In the battery 1, at least one of the attachment portion where the positive electrode terminal 16A is attached to the outer unit and the attachment portion where the negative electrode terminal 16B is attached to the outer unit may have the same structure as that of any of the above-described embodiment and the like. In a case where the attachment portion where the positive electrode terminal 16A is attached to the outer unit has the same structure as that of the above-described embodiment and the like, the positive electrode terminal 16A and the vicinity thereof have the same structure as that of any of the above-described embodiment and the like. In a case where the attachment position where the negative electrode terminal 16B is attached to the outer unit has the same structure as that of the above-described embodiment and the like, the negative electrode terminal 16B and the vicinity thereof have the same structure as that of any of the above-described embodiments and the like.

According to at least one of the embodiment and modifications, the outer unit includes the outer surface counterbore and the inner surface counterbore. The external insulator is fitted to the outer surface counterbore in a state of being sandwiched between the terminal head of the terminal and the outer surface counterbore, and the internal insulator is fitted to the inner surface counterbore in a state of being sandwiched between the lead and the inner surface counterbore. Thus, it is possible to provide a battery in which the airtightness and the like between the terminal and the outer unit provided by the insulating gasket is appropriately secured even when a large load is applied to the terminal.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A battery comprising:
an outer unit including an outer surface counterbore recessed in an outer surface and an inner surface counterbore recessed in an inner surface, and forming an inner cavity;
an electrode group including a positive electrode and a negative electrode, and housed in the inner cavity;
a terminal including a terminal shaft inserted into the inner cavity through the outer unit from the outer surface counterbore to the inner surface counterbore, and a terminal head arranged outside the outer unit;
a lead to which the terminal shaft of the terminal is connected in the inner cavity, and electrically connecting the electrode group and the terminal;
an insulating gasket having an electrical insulation property, and sandwiched between the terminal shaft and the outer unit in a state of covering the terminal shaft from an outer peripheral side;
an external insulator having an electrical insulation property, and fitted to the outer surface counterbore in a state of being sandwiched between the terminal head of the terminal and the outer surface counterbore; and
an internal insulator having an electrical insulation property, and fitted to the inner surface counterbore in a state of being sandwiched between the lead and the inner surface counterbore.

2. The battery according to claim 1, wherein
the lead includes a top plate portion to which the terminal shaft is connected, and
the internal insulator is sandwiched between the top plate portion and the inner surface counterbore, and the top plate portion extends to the outer peripheral side beyond an outer peripheral end of the inner surface counterbore.

3. The battery according to claim 2, wherein the outer peripheral end of the inner surface counterbore is located on an inner peripheral side with respect to an outer peripheral end of the terminal head of the terminal.

4. The battery according to claim 1, wherein an outer peripheral end of the outer surface counterbore is located on an inner peripheral side with respect to an outer peripheral end of the terminal head of the terminal.

5. The battery according to claim 1, wherein
the lead includes a lead protruding portion protruding toward the inner surface counterbore,
the lead protruding portion is located on an inner peripheral side with respect to an outer peripheral end of the inner surface counterbore, and the internal insulator is sandwiched between the lead protruding portion and the inner surface counterbore, and
due to a step formed by the lead protruding portion in the lead, a portion of the internal insulator sandwiched between the lead and the inner surface counterbore has a crank shape in a cross section parallel to an axial direction of the terminal.

6. The battery according to claim 1, wherein
the terminal head of the terminal includes a head protruding portion protruding toward the outer surface counterbore,
the head protruding portion is located on an inner peripheral side with respect to an outer peripheral end of the outer surface counterbore, and the external insulator is sandwiched between the head protruding portion and the outer surface counterbore, and
due to a step formed by the head protruding portion in the terminal head, a portion of the external insulator sandwiched between the terminal head and the outer surface counterbore has a crank shape in a cross section parallel to an axial direction of the terminal.

7. The battery according to claim 1, wherein
the outer unit includes at least one of:
an outer surface convex portion protruding toward the terminal head of the terminal at a bottom surface of the outer surface counterbore, and coming into contact with the external insulator; and
an inner surface convex portion protruding toward the lead at a bottom surface of the inner surface counterbore, and coming into contact with the internal insulator.

8. The battery according to claim 7, wherein the outer surface convex portion and/or the inner surface convex portion is formed over an entire circumference of the terminal in a circumferential direction.

9. The battery according to claim 1, wherein
the insulating gasket includes:
a first flange portion protruding toward the outer peripheral side at an end portion on one side in an axial direction of the terminal, and to which the external insulator is adjacent from the outer peripheral side; and
a second flange portion protruding toward the outer peripheral side at an end portion on a side opposite to the first flange portion in the axial direction of the terminal, and to which the internal insulator is adjacent from the outer peripheral side.

10. The battery according to claim 1, wherein
the outer unit includes:
an outer container including a bottom wall and a peripheral wall, the inner cavity being open to a side opposite to a side where the bottom wall is located; and
a lid member attached to the peripheral wall of the outer container in a state of closing an opening of the inner cavity, the outer surface counterbore and the inner surface counterbore being formed in the lid member, and the terminal shaft of the terminal penetrating the lid member from the outer surface counterbore to the inner surface counterbore.

11. The battery according to claim 1, the battery being at least one of:
a positive electrode terminal being the terminal including the terminal shaft and the terminal head; a positive electrode side lead that electrically connects the positive electrode of the electrode group and the positive electrode terminal being the lead; at an attachment portion of the positive electrode terminal in the outer unit, the outer surface counterbore and the inner surface counterbore being formed; at the attachment portion of the positive electrode terminal, the insulating gasket covering the terminal shaft of the positive electrode terminal from the outer peripheral side; and at the attachment portion of the positive electrode terminal, the external insulator being fitted to the outer surface counterbore in a state of being sandwiched between the terminal head of the positive electrode terminal and the outer surface counterbore, and the internal insulator being fitted to the inner surface counterbore in a state of being sandwiched between the positive electrode side lead and the inner surface counterbore; and
a negative electrode terminal being the terminal including the terminal shaft and the terminal head; a negative electrode side lead that electrically connects the negative electrode of the electrode group and the negative electrode terminal being the lead; at an attachment portion of the negative electrode terminal in the outer unit, the outer surface counterbore and the inner surface counterbore being formed; at the attachment portion of the negative electrode terminal, the insulating gasket covering the terminal shaft of the negative electrode terminal from the outer peripheral side; and at the attachment portion of the negative electrode terminal, the external insulator being fitted to the outer surface counterbore in a state of being sandwiched between the terminal head of the negative electrode terminal and the outer surface counterbore, and the internal insulator being fitted to the inner surface counterbore in a state of being sandwiched between the negative electrode side lead and the inner surface counterbore.
